(19) United States
(12) Patent Application Publication
(10) Pub. No.: US 2012/0207124 A1
(43) Pub. Date: Aug. 16, 2012

(54) Method and Device for Allocating Resources of a Control Channel in a Wireless Communication System

(76) Inventors: Jing Xiu Liu, Chaoyang District (CN); Jeroen Wigard, Klarup (DK); Hao Guan, Beijing (CN); Frank Frederiksen, Klarup (DK); Daniela Laselva, Klarup (DK)

(21) Appl. No.: 13/504,505

(22) PCT Filed: Oct. 29, 2009
(86) PCT No.: PCT/EP2009/064318

§ 371 Date: Apr. 27, 2012

(51) Int. Cl. H04W 72/04

(52) U.S. Cl. 370/329

(57) ABSTRACT

A method and a device for allocating resources of a control channel are provided, wherein said control channel is a control channel of a mobile network, wherein the control channel conveys uplink and downlink allocations, wherein the distribution of uplink and downlink allocations is determined based on traffic requirements. Furthermore, a communication system is suggested comprising said device.

The invention relates to a method and to a device for allocating resources of a control channel.

In 3GPP LTE, resource allocations (e.g., resource blocks) in uplink (UL) and downlink (DL) direction are conveyed to a mobile terminal, e.g., a user equipment (UE), via a physical downlink control channel (PDCCH).

The PDCCH has a limited capacity and thus for each transmission time interval (TTI) a choice has to be made which allocation to send based on both the data channel capacities (in downlink and uplink direction) and the PDCCH capacity.

In an optimal scenario, enough allocations are sent such that
an uplink data channel is fully utilized;
a downlink data channel is fully utilized;
enough users are scheduled to get full gain from a channel aware scheduling;
QoS constraints are maintained.

However, fulfilling all these criteria may in certain cases be rather impossible. In addition, UL applications may typically require less resources than DL applications, because UL traffic largely comprises acknowledgements (e.g., to confirm receipt of DL data transmissions). In addition, the UE may have power limitations in UL direction.

The problem to be solved is to provide an efficient mechanism to efficiently allocate resources of a control channel, in particular of a downlink control channel, and utilize such allocation towards mobile terminals of a wireless communication network.

This problem is solved according to the features of the independent claims. Further embodiments result from the depending claims.

In order to overcome this problem, a method is provided for allocating resources of a control channel
wherein said control channel is a control channel of a mobile network,
wherein the control channel conveys uplink and downlink allocations, wherein the distribution of uplink and downlink allocations is determined based on traffic requirements.

The solution provided may relate to 3GPP LTE Release 8, 9 or 10. In addition, the solution may also be applicable to technologies other than LTE; in such case, parameters and procedures may have to be adapted to the respective technology, interfaces and architecture.

Advantageously, a limited capacity of the control channel, e.g., a PDCCH, can be efficiently utilized to convey resource allocation, e.g., resource blocks, in uplink and downlink direction to a mobile terminal, e.g. a user equipment (UE). The approach allows a timely adaptation of the distribution of uplink and downlink allocations to be notified towards the mobile terminal and hence to efficiently utilize not only the capacity of the control channel, but also to convey the resource information towards the mobile terminals in an efficient manner.

It is noted that the mobile terminal may be any device with a wireless interface to communicate with the mobile network. Such device may be a cellular phone, a (laptop) computer, a handheld device (e.g., personal digital assistant), a car with a mobile interface or the like.

In an embodiment, the control channel is a downlink control channel, in particular a physical downlink control channel.

In another embodiment, the control channel is a channel to notify mobile terminals about resource allocations in uplink direction and downlink direction.

In a further embodiment, said traffic requirements are measured or estimated.

This advantageously allows for a timely response to any changes of the traffic. In particular changes by a scheduler could be taken into account to convey the appropriate resource blocks to the mobile terminals via said control channel.

In a next embodiment, the uplink and downlink allocations are processed via a joint list, wherein entries of said joint are prioritized.

Hence, the joint list advantageously merges an UL list and a DL list and the entries of the joint list are sorted by priority.

It is also an embodiment that data, in particular uplink data, to be retransmitted is associated with a high priority.

Hence, resource blocks for UL retransmissions are of high priority, which is accordingly considered by said joint list. This efficiently avoids any unnecessary delay.

Pursuant to another embodiment, several joint lists are predefined and in particular stored, wherein one of the predefined lists is selected based on a distribution of uplink and downlink allocations that has been determined based on said traffic requirements.

According to an embodiment, said traffic requirements comprise numbers of mobile terminals that are scheduled for uplink and/or downlink traffic.

This number can efficiently be utilized to adjust the distribution between the uplink and downlink allocations of the control channel.

According to another embodiment, said traffic requirements are determined based on buffered information.

For example, the base station (eNB) has the mobile terminal's (UE's) buffer status for downlink, i.e. a buffer length; based on a buffer status report (BSR) provided by the mobile terminal, the base station becomes aware of buffer information of all mobile terminals. Hence, based on the downlink and uplink buffer length information, the base station may determine whether resources are required in downlink or uplink direction.

The problem stated above is also solved by a device for allocating resources of a control channel of a mobile network comprising or being associated with a processing unit that is arranged to execute uplink and downlink allocations conveyed by the control channel, wherein the distribution of uplink and downlink allocations is determined based on traffic requirements.

It is noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

Pursuant to yet an embodiment, the device is a network element, in particular a node of a communication network, in particular a or being associated with a manager module.

According to an embodiment, the manager module is a PDCCH manager comprising a unit that creates and/or selects a joint list.

According to another embodiment, the device is a device used in a 3GPP network, in particular in an LTE network.

The problem stated supra is further solved by a communication system comprising at least one device as described herein.

Embodiments of the invention are shown and illustrated in the following figures:

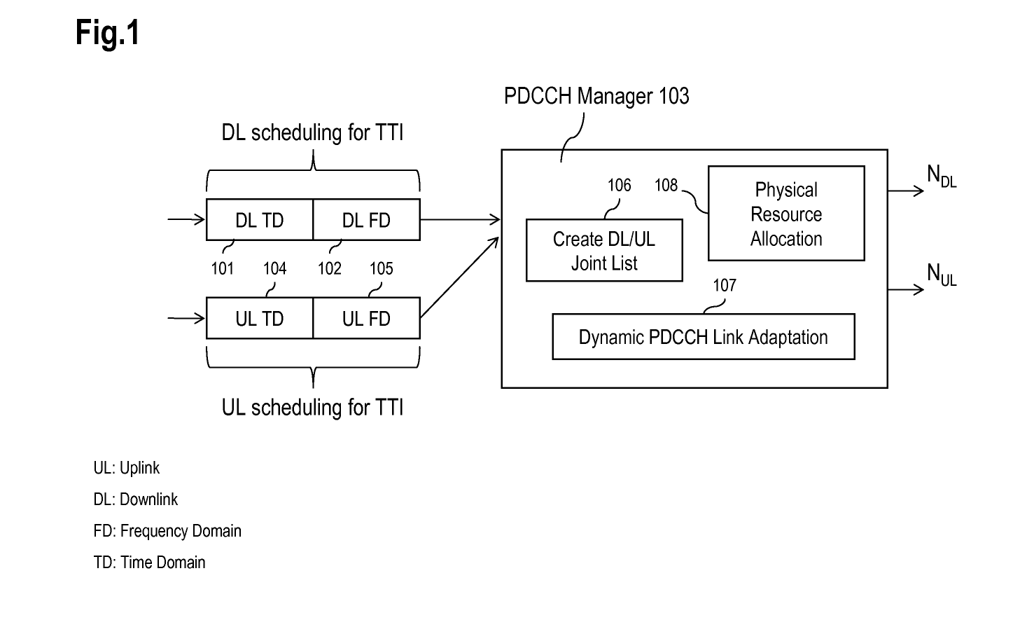

FIG. 1 shows a schematic diagram comprising a PDCCH manager framework for FDD;

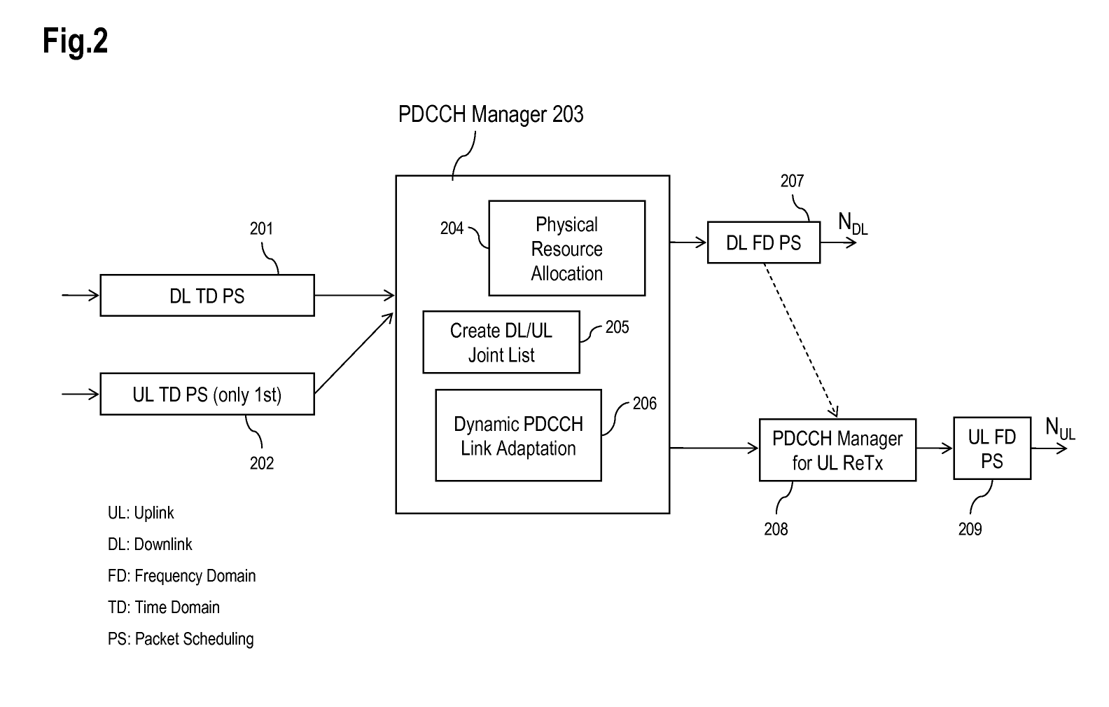

FIG. 2 shows an alternative schematic diagram comprising a PDCCH manager framework considering the limitation of FIG. 1;

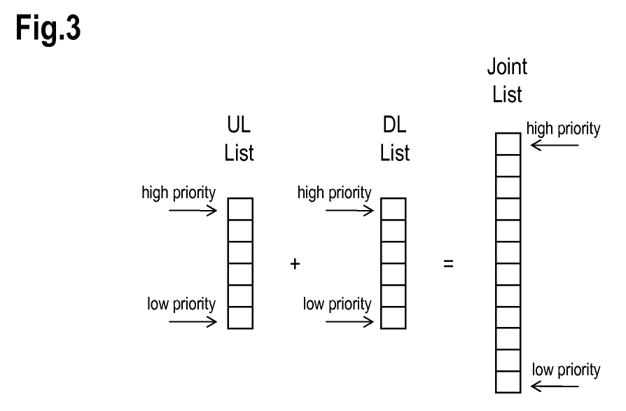

FIG. 3 shows a schematic diagram to visualize a joint list functionality;

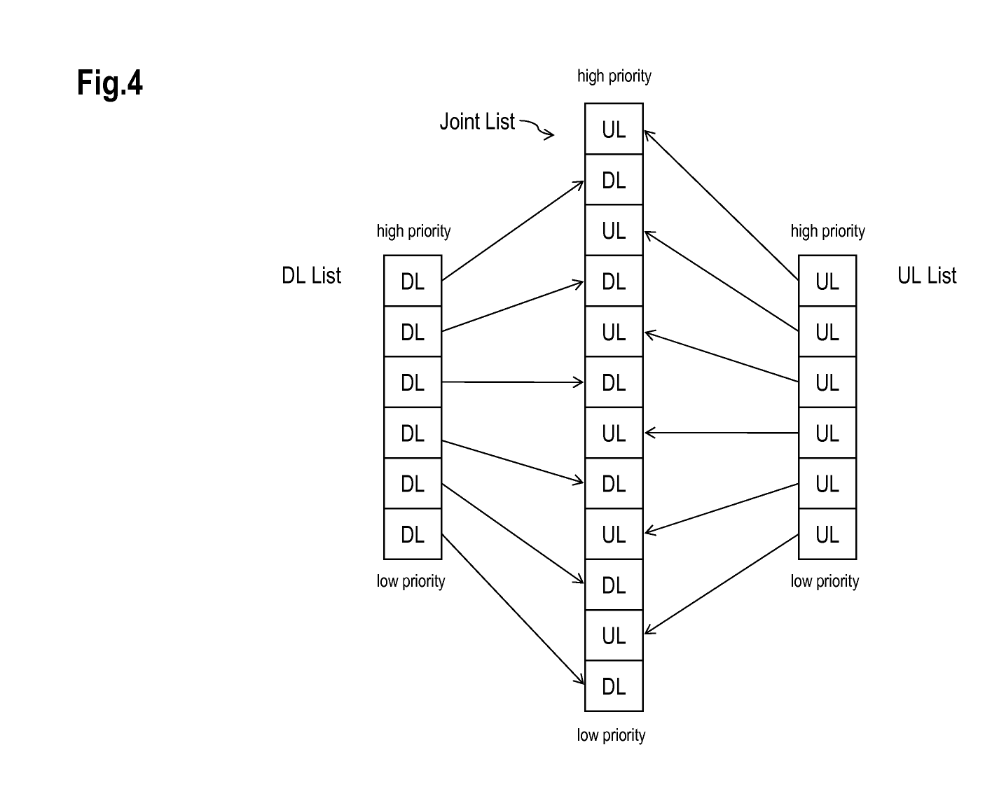

FIG. 4 shows a so-called “zipper approach” as how to merge the DL list and the UL list to a joint list;

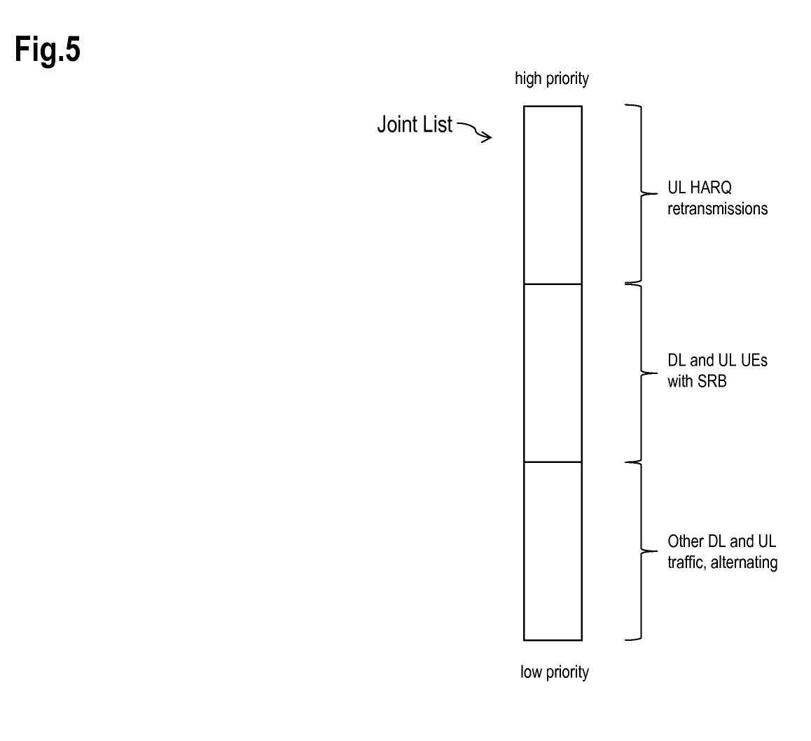

FIG. 5 shows an exemplary joint list comprising three sub-blocks arranged from a high-priority to a low priority;

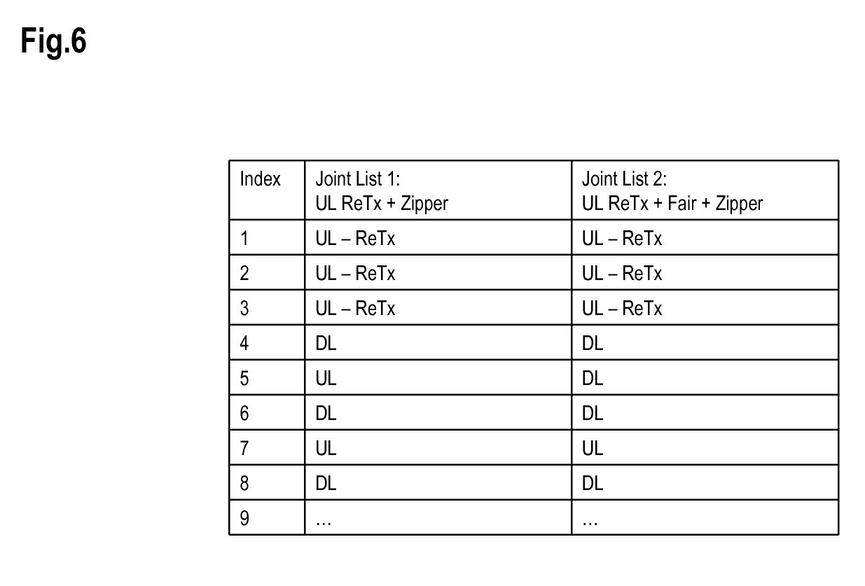

FIG. 6 shows an exemplary table visualizing two options of a merged joint list;

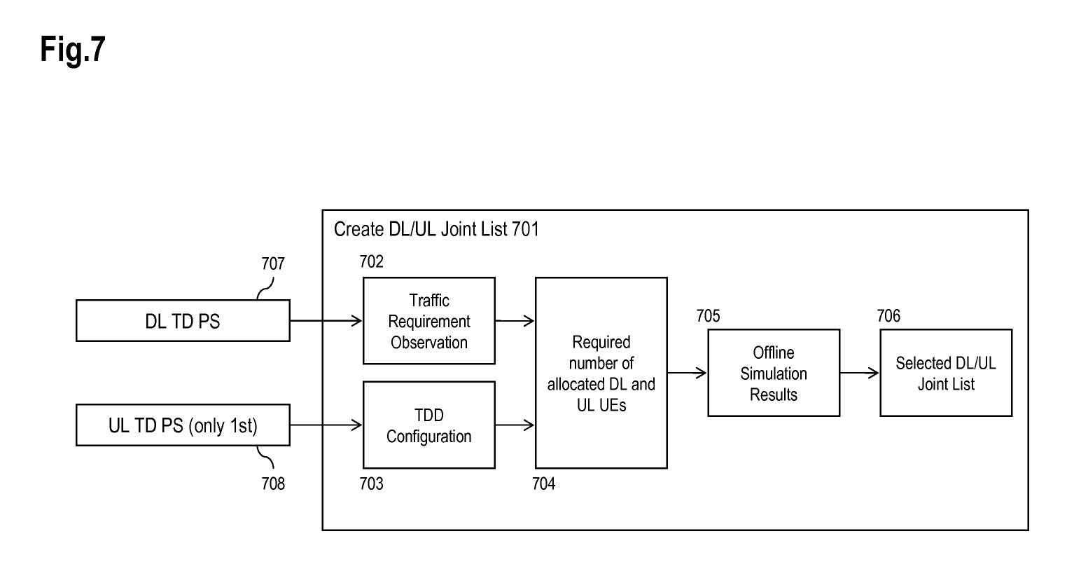

FIG. 7 shows an exemplary block structure of a create DL/UL joint list module comprising several modules to create and/or select a list dependent on various traffic requirements;

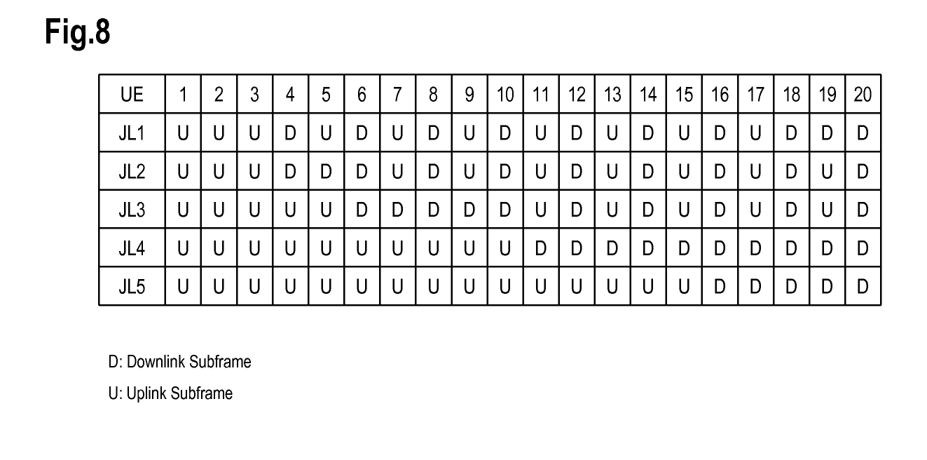

FIG. 8 shows an exemplary table comprising five joint lists.

In an LTE FDD system, physical resources like bandwidth and time slots similarly exist for downlink and uplink directions. Hence, a supported transmission capability or a supported number of UEs may be identical for downlink and uplink, too. However, in some scenarios, the traffic requirement for downlink may be different to the uplink traffic requirement: For example, a web browser requires more downlink transmission resources (e.g., due to several bursts of downloaded data) and less uplink transmission resources (due to large portions of short acknowledgements, e.g., TCP ACK signaling). In such case, a base station (eNB) may need to schedule more uplink UEs and less downlink UEs to efficiently utilize the uplink and downlink resources of the data channel.

In an LTE TDD system, there are seven kinds of DL/UL configurations (also referred to as “TDD configurations”), in which different DL/UL ratios are determined for different traffic requirements. When a neighboring cell has a different DL/UL configuration, severe interference may occur. Hence, a TDD system layout may utilize same DL/UL configurations for neighboring cells distributed throughout a large area. However, a different DL/UL configuration may in particular be applicable for an isolated cell. A change of the DL/UL configuration of neighboring cells shall hence be avoided, which is problematic as traffic in neighboring cells can significantly vary over time. Based on traffic optimization requirements, DL/UL configuration cannot be changed cell by cell due to their interference with adjacent cells. Therefore, the base station (eNB) has to adjust the number of UEs that are scheduled in downlink and in uplink direction.

Based on the above, the base stations (eNBs) have to adjust the number of UEs scheduled in uplink and in downlink direction for both, FDD and TDD systems.

PDCCH Manager

FIG. 1 shows a schematic diagram comprising a PDCCH manager framework for FDD.

A DL scheduling for a transmission time interval (TTI) is conducted comprising a DL time domain (TD) scheduler 101 and a DL frequency domain (FD) scheduler 102, which input is fed to a PDCCH manager 103. Accordingly, an UL scheduling for a TTI is conducted comprising an UL TD 104 and an UL FD 105. The PDCCH manager 103 comprises a unit 106 to create a DL/UL joint list, a dynamic PDCCH link adaptation unit 107 and a physical resource allocation unit 108. As a result, the PDCCH manager 103 provides a number of DL allocations N_{DL} and a number of uplink allocations N_{UL}.

Hence, the time-domain packet scheduling 101, 104 and frequency-domain packet scheduling 102, 105 are implemented independently for downlink and uplink. Then, the UEs selected are supplied to the PDCCH manager 103, in which the DL/UL joint list is created (see unit 106) and PDCCH resources are allocated (see unit 108) based on this DL/UL joint list. Then, the UEs scheduled for DL and UL are informed via the PDCCH. UEs that are blocked by the PDCCH manager 103 will be deleted from the scheduled UE list; hence, the allocated frequency resources for these UEs may be wasted.

FIG. 2 shows an alternative schematic diagram comprising a PDCCH manager framework for FDD considering the limitation of FIG. 1.

A downlink time domain packet scheduling is provided for the downlink direction (see unit 201) and for the uplink direction (see unit 202); the results of the packet scheduling units 201 and 202 are fed to a PCDDH manager 203 comprising a unit 205 to create a DL/UL joint list, a dynamic PDCCH link adaptation unit 206 and a physical resource allocation unit 204. Subsequent to the PDCCH manager 203, a downlink frequency-domain packet scheduling 207 is conducted. Therein-after, a unit 208 comprising a PDCCH manager for UL retransmission (ReTx) and a unit 209 for uplink frequency-domain packet scheduling are provided. This layout allows allocating all frequency resources to the UEs.

The scheduling units 201 and 202 perform a user scheduling in the time domain. The unit 207 conveys potentially non-utilized PDCCH resources for DL UEs that are blocked by DL FD PS towards the unit 208.

The unit 208 may utilize unused resources for UL ReTx. In case of a collision, an UL ReTx may be prioritized over a first UL transmission.

Joint List

The PDCCH manager creates an UL/DL joint list. This joint list refers to a prioritized downlink UE list and to a prioritized uplink UE list, wherein either of these two lists may have its own priority. The joint list merges these two lists together.

PDCCH resources allocation is based on this joint list. Hence, the performance of the system may significantly depend upon the layout or design of this joint list. For example, the higher a priority of an entry in the joint list, the lower is its blocking probability.

FIG. 3 shows a schematic diagram to visualize a joint list functionality. In FIG. 3, an UL list and a DL list are shown, each list comprising several entries, wherein the entries are prioritized in each list from the top down to the bottom (high priority at the top of the list). These two lists may have to be merged to a joint list, which is also prioritized in a top-down manner. However, there are several approaches to provide a prioritized joint list based on the UL list and the DL list.

FIG. 4 shows a so-called “zipper approach” as how to merge the DL list and the UL list to a joint list. The entries of the DL and UL lists are alternately fed to the joint list. This approach, however, does not prioritize any UL retransmission packets and it may therefore cause a significantly delay for UL transmission due to a synchronous HARQ for UL packets in the LTE system.

FIG. 5 shows an exemplary joint list comprising three sub-blocks arranged from a high-priority to a low priority:
UL HARQ retransmission: Transmission in UL direction that need to be repeated with a high priority to avoid any unnecessary delay;
DL and UL UEs with SRB: Data packets that comprise signaling radio bearer (SRB) traffic both in uplink and downlink direction.
Other DL and UL traffic, alternating: Other data packets in uplink and downlink direction allocating resources by turns.

FIG. 6 shows an exemplary table visualizing two options of a merged joint list. An index column indicates the order of entries in the list, wherein a low number indicates a high priority. A joint list 1 considers UL retransmission as well as the aforementioned zipper approach. The top three fields comprise data packets to be re-transmitted in UL direction (high priority), then DL and UL traffic take turns. A joint list 2 considers UL retransmission, the zipper approach and a some-what “fair” distribution of traffic. Hence, the top three fields of high priority are as well used to re-transmit UL traffic. Then, DL traffic, which has not been sent due to the re-transmission, is conveyed before the UL and the DL again take turns.

Parameters of PDCCH manager, e.g., parameters for joint lists may be configured by an O&M module in a semi-static manner. It is rather difficult and impossible to exactly predict or measure and hence pre-configure the different traffic requirements between downlink and uplink, in particular as no such information is fed back from a physical or MAC layer to the O&M module during a configuration phase. Therefore, even when the traffic distribution between DL and UL does not match the allocated DL and UL resources, O&M cannot adjust the parameters of the PDCCH manager. This even applies to a scenario where the PDCCH manager has the flexibility to adjust the parameters for joint lists, e.g., the allocated DL and UL resources.

Hence, it is in particular suggested to provide an efficient joint list processing mechanism. For example, a PDCCH manager may comprise a joint list creation module providing in particular at least one of the functionalities as set forth below. At least one of these functions may be implemented or provided via a separate module or be associated with the PDCCH manager and/or the joint list creation module.

FIG. 7 shows an exemplary block structure of a create DL/UL joint list module 701 comprising a traffic requirement observation module 702 and a TDD configuration module 703. The output of each module 702, 703 is fed to a module 704 that determines a number of DL and UL UEs required and further to a module 705 that comprises offline simulation results. Then, a joint list is selected in a module 706. The module 701 may be part of the PDCCH manager 203 as shown in FIG. 2.

It is noted that the block structure shown in FIG. 7 could be implemented by a person skilled in the art as a single physical unit, as several physical components or it could be associated or arranged with an existing logical or physical entity. The blocks shown within the module 701 could be logical entities that may be deployed as program code, e.g., software and/or firmware, running on a processing unit, e.g., a computer, microcontroller, ASIC, FPGA and/or any other logic device.

Accordingly, the module 701 shows a device for allocating resources of a control channel of a mobile network. There may be at least one physical or logical processing unit that is arranged to execute uplink and downlink allocations, e.g., by utilizing said module 706, conveyed by the control channel, wherein the distribution of uplink and downlink allocations is determined based on traffic requirements, which may be determined by modules 702 and/or 703, e.g., in combination with modules 704 and 705 as described herein.

Also, the schedulers 707, 708 depicted in FIG. 7 could be implemented as separate (logical or physical) entities or they could be deployed with an existing component, e.g., a network component of an LTE network.

Traffic Requirement Observation/Estimation Module 702:

This module 702 is used to estimate, measure and/or predict the required DL and UL resources for the UEs. The module 702 obtains its input from a downlink time domain packet scheduler 707.

For example, the module 702 may determine the number of DL and UL resources required for the UEs; as an alternative, the module 702 may determine (e.g., in cooperation with other modules), whether the systems has a high need for UL resources or for DL resources. At least one of the following options may be applicable:
(a) The module 702 may monitor the past allocations conducted by the PDCCH manager and the scheduler 707. If more DL physical resource blocks (PRBs) are unused (empty) compared to UL PRBs, the PDCCH manager may have to pass more UL resources towards the UEs.
(b) A scheduling metric of a required activity detection (RAD) scheduler or any other QoS aware metric for DL and/or UL can be monitored. If the RAD scheduler or any other QoS metric indicates a higher need for DL than for UL traffic, the PDCCH manager may have to convey more DL resources towards the UEs, so as to mitigate the requirement of DL QoS-aware UEs. This criterion is in particular useful if there are a significant amount of best-effort UEs in addition to QoS UEs. If all the DL resources are allocated to the QoS UEs, there may be no additional resources to be allocated.
(c) The number of scheduled UEs for DL and UL are monitored. In case more DL UEs are scheduled, the PDCCH manager may have to convey more DL resources towards the UEs.
(d) Buffered information can be utilized, e.g., number of bits and QoS. For example, the eNB may be aware of the downlink buffer status of all UE's, i.e. the respective buffer lengths; based on a BSR reported by each UE, the eNB is also aware of the buffer information of all the UEs. Hence, based on the downlink and uplink buffer length information, the eNB can decide whether more (or less) resources are required in downlink or in uplink direction.

TDD Configuration Module 703:

This module 703 may be applicable in a TDD system and may be omitted or disabled in a pure FDD system.

The module 703 is provided with information from the uplink time domain packet scheduler 708 for the first packet (no retransmission).

In the TDD system, the module 703 may output a DL and a UL slot ratio including a special subframe, based on a system configuration.

For example, in a TDD configuration 2 (DSUDD) with a special subframe configuration 2 (10:2:2), the DL:UL slot ratio amounts to approximately 3.7:1.

It is noted that “DSUDD” is the TDD configuration 2 as stated in 3GPP TS 36.211 V8.5.0 Page 11, wherein “D” refers to a downlink subframe, “U” refers to an uplink subframe and “S” refers to a special subframe. “TDD Configuration 2” refers to the “Uplink-downlink configuration” set to “2” according to table 4.2-2 of 3GPP TS 36.211 V8.5.0. A guard period exists for all TDD uplink-downlink configurations, wherein “10:2:2” refers to the “special subframe configuration=2” and in the special subframe, there are 10 symbols for downlink and 2 symbols guard period and 2 symbols for uplink arranged in sequence.

Module 704: Required Number of Allocated DL and UL UEs:

This module 704 determines or estimates the required number of allocated DL and UL UEs to be passed by PDCCH manager based on inputs from the previous modules 702 and 703.
(a) In the FDD system, if the output from the module 702 indicates that the system needs more DL UEs, the number of required UEs passed by PDCCH manager is updated as follows:

N_DL_new=N_DL_old+delta; and

N_UL_new=N_UL_old−delta;
wherein
   N_DL indicates the number of DL resources;
   old indicates the previous value;
   new indicates an updated value;
   delta indicates the number of UEs or resources that are additionally required in downlink direction.
For example, if the output from the module 702 indicates that the system needs 15 DL UEs and less UL UEs, then

N_DL_new=15;

N_UL_new=k−N_DL_new;
wherein k is one value (constant) that may be determined by a hash function.
(b) In the TDD system, an impact of an unbalanced DL/UL slot within one TTI is to be considered.
   For example, some “D” subframes (or “S” subframes) contain only DL grants, others subframes contain both DL and UL grants. Therefore, if the system wants to set the allocated DL/UL ratio to 3 in the TDD configuration 2 (DSUDD) and special subframe configuration 2 (10:2:2), a new number of DL resources (N_DL_new) and a new number of uplink resources (N_UL_new) are to be determined: In this configuration, subframe 0/1/4 contains only DL grant and subframe 3 contains both DL and UL grant. Hence, the PDCCH manager's joint list parameters in subframe 3 can be adjusted:

(2.7*N_DL_in_DLGrantOnly_Subframe++N_DL_in_SF3)/(N_UL_in_SF3)=3; (1)

N_DL_in_SF3+N_UL_in_SF3=const. (2)
wherein
   N_DL_in_DLGrantOnly_Subframe
      indicates the number of allocated downlink UEs by the PDCCH manager in the downlink or special subframes that only allow DL grants;
   N_DL_in_SF3
      indicates the number of allocated downlink UEs by the PDCCH manager in the downlink or special subframe that have both DL grants and UL grants; in this example, the #3 subframe is such kind of subframe.
      With regard to “DSUDD”, the subframe index ranges from 0 to 4.
   N_UL_in_SF3
      indicates the number of allocated uplink UEs by the PDCCH manager in the downlink or special subframe that have both DL grants and UL grants. In this example, the #3 subframe is such kind of subframe.
The constant in equation (2) and “N_DL_in_DLGrantOnly_Subframe” in equation (1) can be determined based a hash function model and may advantageously be known beforehand. Therefore N_DL_in_SF3 and N_UL_in_SF3 can be determined via the system of equations (1), (2).

Offline Simulation Results Module 705:

This module 705 comprises pre-calculated results of allocated UE numbers for different joint list options, including both DL and UL. FIG. 8 shows an exemplary table comprising five joint lists that could be stored with the module 705.

In FIG. 8, the first line “UE” refers to a UE index in the joint list. This UE index is just for indexing for joint list, and the UE index is independent from the UE's identification (ID). For example, UE index 1 refers to the UE with the highest priority in the joint list, wherein the UE's ID could be, e.g., 5 or 100.

Select Joint List Module 706:

Based on the previously gathered information from the modules, the one joint list which meets the required number of DL and UL resources that are passed by the PDCCH manager are selected and fed to the further modules of the PDCCH manager.

Further Advantages

The approach suggested can be applied in a base station (e.g., eNB) and it can deal with the traffic requirement fluctuation in a semi-static way (e.g., larger than 1 TTI and less than 1 year).

### LIST OF ABBREVIATIONS

ACK Acknowledgement

BSR Buffer Status Report

CCE Control Channel Elements

D downlink subframe

DL downlink

eNB evolved NodeB (e.g., base station)

FD Frequency Domain

FDD Frequency Division Duplexing

HARQ Hybrid Automatic Repeat Request

JL Joint List

LTE Long-Term Evolution

MAC Media Access Control

O&M Operation and Maintenance

PDCCH Physical Downlink Control Channel

PRB Physical Resource Block

PS Packet Scheduling

QoS Quality of Service

RAD Required Activity Detection

ReTx retransmission

S special subframe

SRB Signaling Radio Bearer

TCP Transmission Control Protocol

TD Time Domain

TDD Time Division Duplexing

TTI Transmission Time Interval

U uplink subframe

UE User Equipment

UL uplink

1. A method for allocating resources of a control channel,
wherein said control channel is a control channel of a mobile network,
wherein the control channel conveys uplink and downlink allocations, wherein the distribution of uplink and downlink allocations is determined based on traffic requirements.

2. The method according to claim 1, wherein the control channel is a downlink control channel, in particular a physical downlink control channel.

3. The method according to claim 1, wherein the control channel is a channel to notify mobile terminals about resource allocations in uplink direction and downlink direction.

4. The method according to claim 1, wherein said traffic requirements are measured or estimated.

5. The method according to claim 1, wherein said traffic requirements are measured or estimated based on previously recorded or utilized values.

6. The method according to claim 1, wherein the uplink and downlink allocations are processed via a joint list, wherein said joint list is prioritized.

7. The method according to claim 6, wherein data, in particular uplink data, to be retransmitted is associated with a high priority.

8. The method according to claim 6, wherein several joint lists are predefined and in particular stored, wherein one of the predefined lists is selected based on a distribution of uplink and downlink allocations that has been determined based on said traffic requirements.

9. The method according to claim 1, wherein said traffic requirements comprise numbers of mobile terminals that are scheduled for uplink and/or downlink traffic.

10. The method according to claim 1, wherein said traffic requirements are determined based on buffered information.

11. A device for allocating resources of a control channel of a mobile network comprising or being associated with a processing unit that is arranged to execute uplink and downlink allocations conveyed by the control channel, wherein the distribution of uplink and downlink allocations is determined based on traffic requirements.

12. The device according to claim 11, wherein said device is a communication device, in particular a or being associated with a manager module.

13. The device according to claim 12, wherein the manager module is a PDCCH manager comprising a unit that creates and/or selects a joint list.

14. The device according to claim 11, wherein said device is a device used in a 3GPP network, in particular in an LTE network.

15. Communication system comprising the device according to claim 11.
